(19) United States
(12) Patent Application Publication
(10) Pub. No.: US 2001/0032552 A1
(43) Pub. Date: Oct. 25, 2001

(54) Juicer accessory and juicer therewith

(76) Inventors: Carlos F. Egana, Maracay (VE); Gonzalo Egana-Benedetti, New York, NY (US); Anthony A. DiBitonto, Brooklyn, NY (US); Ian L. Halpern, New York, NY (US); Mark D. Promell, Brooklyn, NY (US)

Correspondence Address: Steven B. Pokotilow, Stroock & Stroock & Lavan LLP, 180 Maiden Lane, New York, NY, 10038, US

(21) Appl. No.: 09/761,088

(22) Filed: Jan. 16, 2001

Related U.S. Application Data
(60) Provisional application No. 60/176,203, filed on Jan. 14, 2000.

(51) Int. Cl. B30B 9/02; A23N 1/00

(52) U.S. Cl. 100/213; 99/495; 99/510; 99/506

(57) ABSTRACT

A juicer accessory, and a juicer having the juicer accessory, are provided for allowing juice extraction from small fruit and vegetables, such as grapes and berries, as well as, fruit and vegetables cut into slabs, such as pineapples and mangoes. The juicer accessory includes a strainer and a pressing member, which are each formed with a plurality of ridges. The ridges are shaped and arranged to mesh. Consequently, the ridges aid in holding fruit and vegetables during juice extraction, as well as, in rupturing any skin on the fruit and vegetables.

### CROSS-REFERENCE TO RELATED APPLICATION

This Application claims priority of U.S. Provisional Application No. 60/176,203, filed Jan. 14, 2000.

### BACKGROUND OF THE INVENTION

In the prior art, manually operated juicers are known for extracting juice from fruit and vegetables. One such prior art juicer is disclosed in U.S. Pat. No. 6,155,164 to Egaña et al., to the assignee herein.

Juicers, such as that disclosed in U.S. Pat. No. 6,155,164, are used typically to extract juice from a sliced portion of a fruit or vegetable. For example, an orange is cut into two pieces, with each piece being consecutively placed into the juicer and compressed to have its juice extracted. To facilitate this process, a strainer accessory, often having a generally conical or hemispherical shape (such as that shown in U.S. Pat. No. 6,155,164) is provided. As such, upon compression within the juicer, the skin of the fruit or vegetable (e.g. orange) is compressed down against the strainer in relatively full face-to-face contact, so as to maximize juice extraction. Likewise, the strainer can be used with other fruits and vegetables, such as lemons, limes, and tomatoes.

The prior art conical or hemispherical strainer, however, is not designed to efficiently accommodate relatively small fruit and vegetables, such as grapes. Such fruits or vegetables could only be placed around the lowest portion of the strainer, thereby, inefficiently utilizing only a small portion of the strainer surface during juice extraction. Also, fruits and vegetables cut into slabs, which is often done with pineapples and mangoes, do not work well with the aforementioned prior art strainer because of its shape.

### SUMMARY OF THE INVENTION

The deficiency of the prior art is overcome by the subject invention, which provides a juicer assembly for accommodating small fruits and vegetables, in particular grapes and berries, and fruits and vegetables cut into slabs, such as pineapples and mangoes. The subject invention basically comprises two components, a cup-shaped strainer and a generally flat pressing member. The strainer and the pressing member are each formed with ridges that mesh with the pressing member being slid into the strainer. Preferably, each of the strainer and the pressing member are formed with annular, triangular ridges which are concentrically arranged.

For purposes of illustrating the invention, reference will be made to the use of the invention with fruit. It is to be understood that the invention is not limited for use with fruit and can be used in other applications, such as with vegetables.

In use, fruit, that is to be subjected to a juicer, is placed into the strainer. It should be noted that if the fruit is to be washed before juicing (typically done with unsliced fruit), the fruit can be rinsed under a faucet while disposed in the strainer. The strainer then is nested into a holding member of a juicer. With the pressing member being mounted on a pressing ram of the juicer and upon actuating the juicer, the pressing ram, via the pressing member, applies compressive force to the fruit. The ridges of the pressing member and the strainer cooperate to hold the fruit in place and aid in rupturing the skin thereof, if present. With unsliced fruit, as is readily apparent, the skin must be broken to allow for extraction of juice. Extracted juice is passed through apertures in the strainer, while fruit remnants, such as pulp and skin, are trapped between the meshed ridges.

These and other features will better understood through a study of the following detailed description and accompanying drawings.

### BRIEF DESCRIPTION OF THE DRAWINGS

For a fuller understanding of the invention, reference is made to the following description taken in connection with the accompanying drawings, in which:

FIG. 1 is a perspective view of a strainer of the subject invention;

FIG. 2 is a perspective view of a pressing member of the subject invention;

FIG. 3 is a bottom perspective view of the strainer;

FIG. 4 is a perspective view of the strainer nested in a holding member of a juicer;

FIG. 5 is a cross-sectional view of a juicer with the strainer and pressing member mounted thereon;

FIG. 6 is an exploded view of the pressing member and a cooperating locking ring located in a pressing ram of a juicer; and,

FIG. 7 is a partial view of ridges formed on the pressing member meshing with ridges formed on the strainer, with remnants of fruit being trapped therebetween.

### DETAILED DESCRIPTION OF THE INVENTION

Reference is made to the FIGS., wherein a strainer 10 and a pressing member 12 are shown which collectively form a juicer accessory. The juicer accessory can be advantageously used in a juicer to extract juice from small fruit, such as grapes and berries, and to extract juice from fruit cut into slabs, such as pineapples and mangoes.

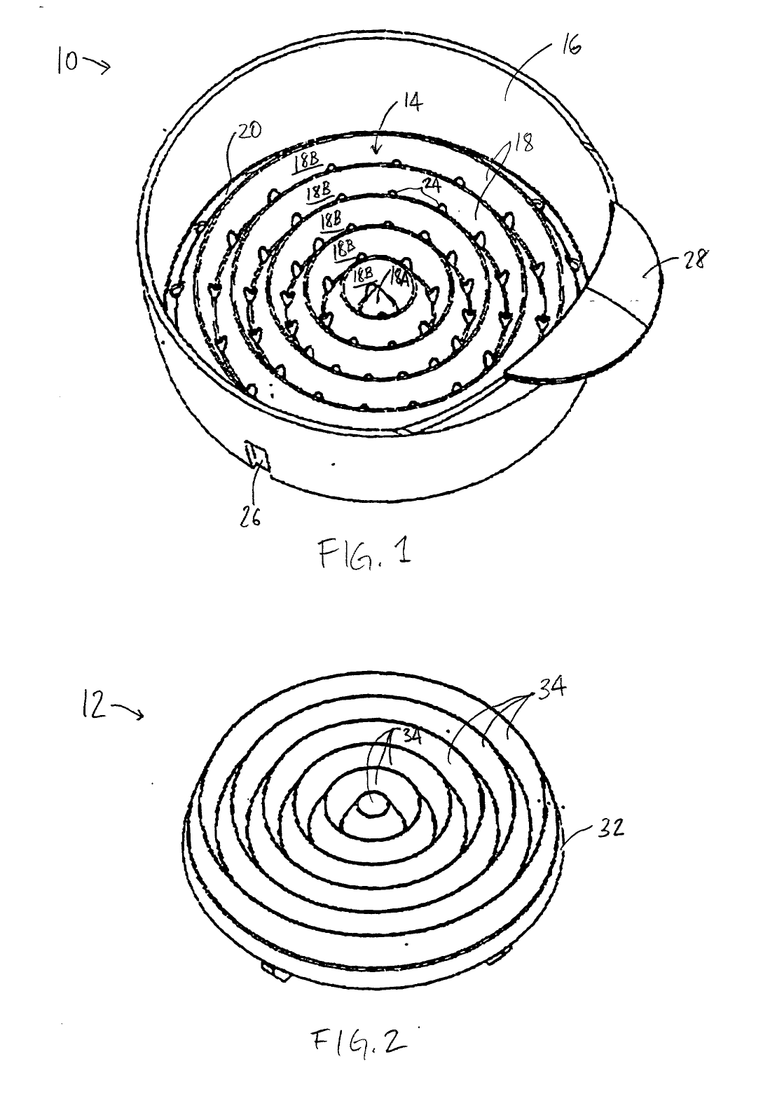

Referring to FIG. 1, the strainer 10 is generally cup-shaped having a bottom 14 and an upstanding side wall 16 that bounds the bottom 14. The strainer 10 is preferably unitarily formed to keep the number of components in the juicer accessory to a minimum and to ease cleaning. Also, the strainer 10 is made of any washable material, in particular material which can be safely used in a dishwasher, including metal or plastic.

A plurality of first ridges 18 is formed on the bottom 14. In a preferred embodiment, one of the first ridges 18 (having the designation 18A) is disposed centrally on the bottom 14 and is formed with a generally conical shape; the majority of the first ridges 18 (having the designation 18B) have triangular cross-sections, are annular in shape and are arranged concentrically about the central first ridge 18A. It also preferred that the first ridges 18 be only formed on an upper surface 20 of the bottom 14. As shown in FIG. 3, it is preferred that the bottom 14 have a generally flat lower surface 22.

A plurality of apertures 24 are formed through the upper and lower surfaces 20 and 22 of the bottom 14. The apertures 24 allow for the passage of extracted juice, as described below. It should be noted that the apertures should be limited in size to prevent the passage therethrough of undesired pulp, seeds, pieces of skin, etc. It is preferred that the apertures 24 not be located on the first ridges 18. As such, the apertures 24 will be located at gravitational low points in the strainer 10 to maximize the amount of extracted juice that is to be passed therethrough.

The side wall 16 preferably has at least one notch 26 defined thereon to cooperate with a protrusion formed on a juicer, as described below, and the notch 26 is preferably blind (does not extend through the side wall 16). Also preferably, a handle 28 extends from a portion of the side wall 16. The handle 28 may be formed of any material that is comfortable to grip and handle, such as soft rubber—although such material must be washable and is preferably dishwasher-safe.

With reference to FIG. 3, supports 30 may also be located on the lower surface 22 of the strainer 10. The supports 30 are intended to provide additional rigidity to the bottom 14 during a juice extraction procedure.

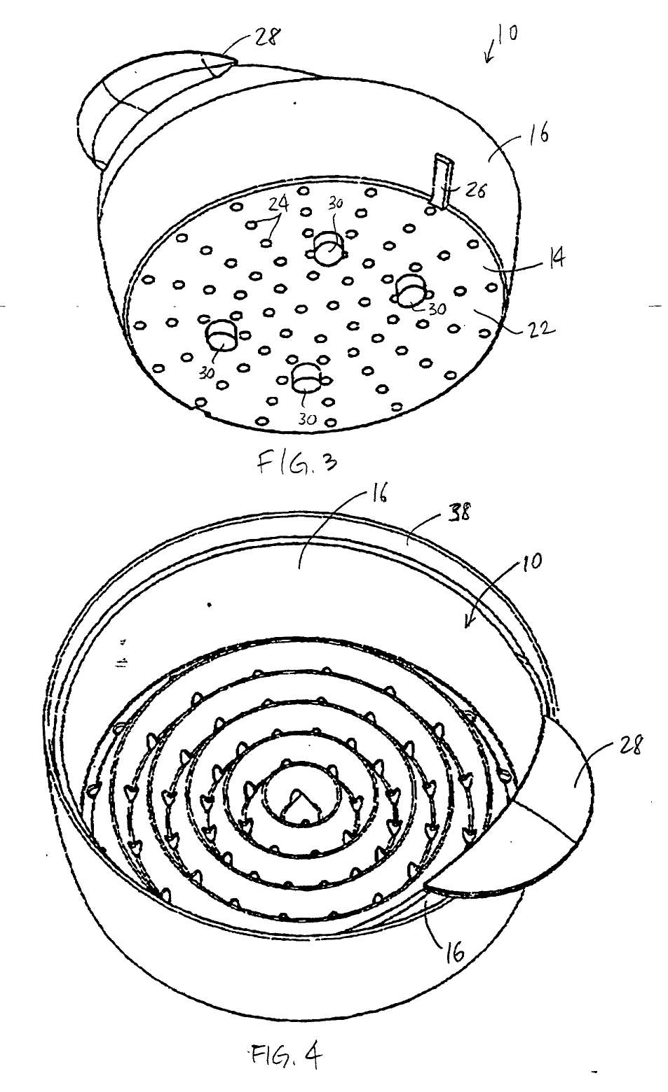

With respect to FIG. 2, the pressing member 12 includes a generally flat engaging member 32 shaped to slide into the strainer 10. As with the strainer 10, it is preferred that the pressing member 12 be unitarily formed of a dishwasher safe material. A plurality of second ridges 34 extends from the engaging member 32, which are preferably triangular shaped in cross-section, annular and arranged concentrically.

For purposes of the subject invention, it is critical that the first ridges 18 of the strainer 10 be shaped and arranged to mesh with the second ridges 34 of the pressing member 12 with the engaging member 32 being slid into the strainer 10. It is preferred that in meshing engagement, the first ridges 18 and the second ridges 34 be generally in substantially full engaging contact. Although the invention is described above with respect to concentric, annular ridges having triangular cross-sections, other cooperating shapes, arrangements and cross-sections are possible, as will be recognized by those skilled in the art.

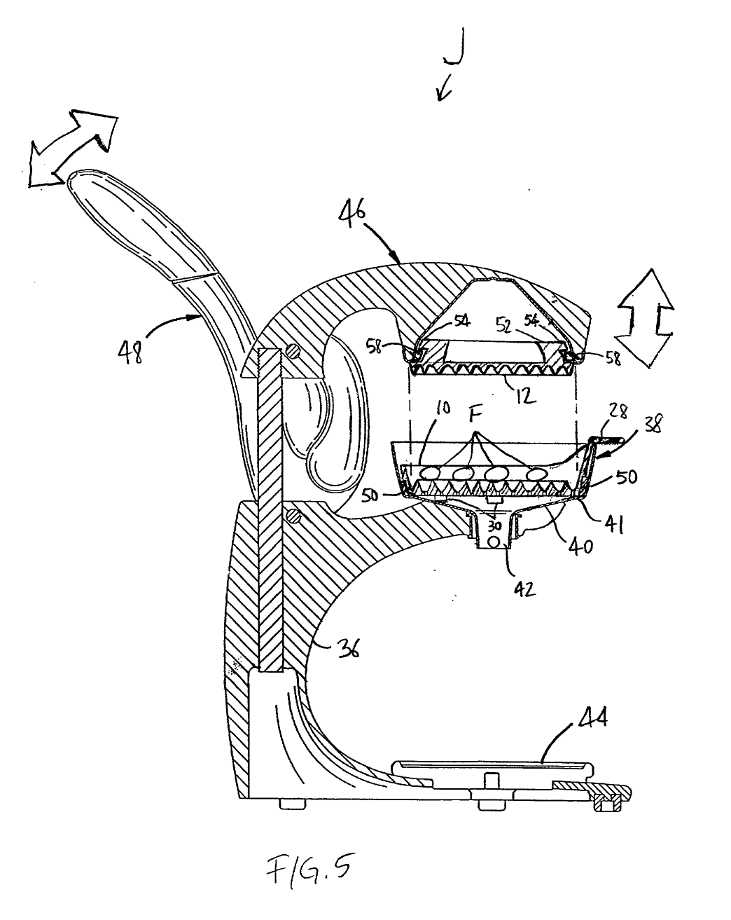

With respect to FIG. 5, the juicer accessory is used in conjunction with a juicer J. The juicer J may be of any type known in the prior art, including that disclosed in U.S. Pat. No. 6,155,164. The entire disclosure of U.S. Pat. No. 6,155,164 is incorporated by reference herein. FIG. 5 herein is based on FIG. 4 of U.S. Pat. No. 6,155,164.

To briefly describe the juicer J, a stationary support 36 is provided on which is mounted a base portion 38. The base portion 38 is generally cup-shaped and formed with a tapered bottom 40 that terminates in a funnel 42. The tapered bottom 40 may have an annular generally flat perimeter portion 41. Any juice that is extracted by the juicer J is directed by the base portion 38 into the funnel 40. A pad 44 is located below the funnel 42 to support a receptacle (not shown) for collecting any extracted juice. In addition, the juicer J is formed with a pressing ram 46 that is movable towards and away from the base portion 38 through manual actuation of handle 48. The pressing ram 46 applies compressive force to any fruit located on the base portion 38 to cause juice extraction therefrom. A complete description of the juicer J, and its operation, is found in U.S. Pat. No. 6,155,164.

Any method known to those skilled in the art may be used to mount the strainer 10 to the base portion 38. It is preferred that the strainer 10 be detachable to allow for cleaning thereof. By way of non-limiting example, as shown in FIG. 4, the strainer 10 can be mounted onto the base portion 38 by nesting the strainer 10 within the base portion 38. Here, the strainer 10 rests upon the flat perimeter portion 41. When mounted, it is preferred that the strainer 10 be wholly recessed within the base portion 38. In this manner, extracted juice can be contained within the base portion 38 during the extraction process. It is also preferred that when the handle 28 is provided, the handle 28 be formed to extend from the base portion 38 with the strainer 10 being mounted thereto, to facilitate removal of the strainer 10 from the base portion 38. To achieve these twin objectives, the side wall 16 extends upwardly in proximity to the handle 28 to provide sufficient clearance for the handle 28 to extend from the base portion 38, whereas, remaining portions of the side wall 16 are formed at a constant lower height recessed within the base portion 38.

In addition, as shown in FIG. 5, it is preferred that at least one protrusion 50 be formed in the base portion 38 to extend into the notch 26 formed in the side wall 16 of the strainer 10. The number, shape and locations of the protrusions 50 are selected to correspond to that of the notches 26. The interengagement of the notches 26 and the protrusions 50 prevents rotation, and altogether limits movement, of the strainer 10 relative to the base portion 38. Also, the supports 30, if any, should be formed and located to abut the tapered bottom 40. Thus, in addition to the support provided by the perimeter portion 41, the supports 30, through the tapered bottom 40, provide additional rigidity to the bottom 14 of the strainer 10 against compressive force being applied thereto.

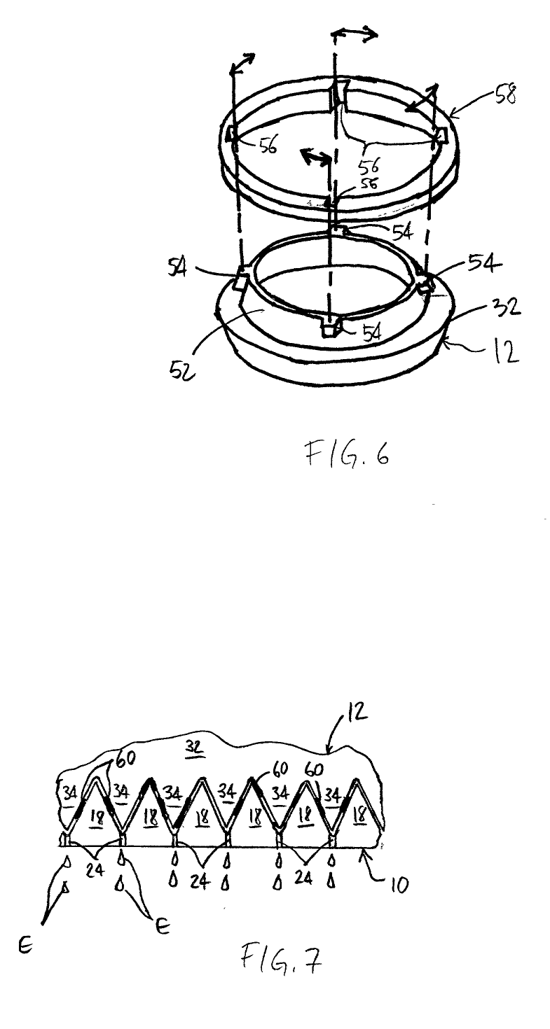

The pressing member 12 is mounted to the pressing ram 46, using any technique known to those skilled in the art. Although the pressing member 12 may be rigidly mounted onto the pressing ram 46, it is preferred that the pressing member 12 be detachable to allow for cleaning thereof. By way of non-limiting example, a bayonet locking arrangement may be utilized to achieve detachable mounting. With reference to FIG. 6, the pressing member 12 is formed with a shoulder 52 that protrudes from the engaging member 32. Any number of locking tabs 54 (four are shown) are formed to extend from the shoulder 52, while a corresponding number of recesses 56 are formed in a locking ring 58. The recesses 56 are formed to allow the passage therethrough of the locking tabs 54. To achieve bayonet locking of the pressing member 12 to the locking ring 58, the locking tabs 54 are aligned with the recesses 56 and caused to pass therethrough. Thereafter, the entire pressing member 12 is caused to rotate relative to the locking ring 58, thereby misaligning the locking tabs 54 and the recesses 56. As such the pressing member 12 can not be pulled through the locking ring 58, in a direction opposite to the direction of entry of the pressing member 12. Referring to FIG. 4, the locking ring 58 is either rigidly mounted to or unitarily formed with the pressing ram 46.

In use, fruit F, such as grapes, are placed within the strainer 10. If the fruit F is unsliced, it may be desired to rinse the fruit F by removing the strainer 10 and placing it under running water with the fruit F therein. With the strainer 10 nested within the base portion 38, the juicer J may be actuated with movement of the handle 48. As a result, the pressing ram 46 moves towards the base portion 38 with compressive force being eventually applied to the fruit F. Upon further movement, the first ridges 18 and the second ridges 34 cooperate to hold the fruit F in place and aid in rupturing any skin that may be on the fruit F. With reference to FIG. 7, the first ridges 18 and the second ridges 34 mesh with any extracted juice E being urged through the apertures 24 in the strainer 10. The extracted juice E is then fed to the funnel 42 in the base portion 38. Desirably, unwanted remnants 60, such as pulp, seeds, skin fragments, and so on, are trapped between the meshed first ridges 18 and second ridges 34.

It will thus be seen that the objects set forth above, among those made apparent from the preceding description, are efficiently attained and, since certain changes may be made in carrying out the above construction without departing from the spirit and scope of the invention, it is intended that all matter contained in the above description and as shown in the accompanying drawings shall be interpreted as illustrative and not in a limiting sense.

It also to be understood that the following claims are intended to cover all the generic and specific structures of the invention herein described and all statements of the scope of the invention which, as a matter of language might be said to fall therebetween.

What is claimed is:

1. A juicer accessory comprising:
a cup-shaped strainer having a bottom, an upstanding side wall bounding said bottom, and a plurality of apertures, wherein a plurality of first ridges is formed in said bottom; and,
a pressing member having a generally flat engaging member, said engaging member being formed to slide into said strainer, wherein a plurality of second ridges is formed on said engaging member, said second ridges being shaped and arranged to mesh with said first ridges with said engaging member being slid into said strainer.

2. A juicer accessory as in claim 1, wherein at least a majority of said first ridges are annular shaped, and wherein said second ridges are annular shaped.

3. A juicer accessory as in claim 2, wherein said annular first ridges are concentrically arranged on said bottom of said strainer.

4. A juicer accessory in claim 3, wherein said second ridges are concentrically arranged on said engaging member.

5. A juicer accessory as in claim 1, wherein said apertures are formed in said bottom of said strainer, said apertures not being located on said first ridges.

6. A juicer accessory as in claim 1, wherein a handle extends from said side wall of said strainer.

7. A juicer comprising:
a base portion;
a pressing ram selectively movable towards and away from said base portion;
a cup-shaped strainer mounted to said base portion, said cup-shaped strainer having a bottom, an upstanding side wall bounding said bottom, and a plurality of apertures, wherein a plurality of first ridges is formed in said bottom; and,
a pressing member mounted to said pressing ram, said pressing member having a generally flat engaging member, said engaging member being formed to slide into said strainer with said pressing ram moving towards said base portion, wherein a plurality of second ridges is formed on said engaging member, said second ridges being shaped and arranged to mesh with said first ridges with said engaging member being slid into said strainer.

8. A juicer as in claim 7, wherein a handle extends from said side wall of said strainer.

9. A juicer as in claim 8, wherein said handle extends from said base portion with said strainer being mounted to said base portion.

10. A juicer as in claim 8, wherein all portions of said side wall from which said handle does not extend from are recessed within said base portion with said strainer being mounted to said base portion.

11. A juicer as in claim 7, wherein at least one notch is formed in said side wall of said strainer, and wherein at least one protrusion extends from said base portion, said protrusion being formed to extend into said notch with said strainer being mounted to said base portion.

12. A juicer as in claim 7, wherein said pressing member is detachably mounted to said pressing ram.

13. A juicer as in claim 12, wherein said pressing member is formed with a shoulder protruding from said engaging member, at least one locking tab extending from said shoulder, and wherein said pressing ram having a locking ring located therein, at least one recess being formed in said locking ring to allow the passage therethrough of said locking tab, said locking ring and said locking tab being formed to cooperatively bayonet lock.

14. A juicer as in claim 7, wherein at least a majority of said first ridges are annular shaped, and wherein said second ridges are annular shaped.

15. A juicer as in claim 14, wherein said annular first ridges are concentrically arranged on said bottom of said strainer.

16. A juicer as in claim 15, wherein said second ridges are concentrically arranged on said engaging member.

17. A juicer as in claim 7, wherein said apertures are formed in said bottom of said strainer, said apertures not being located on said first ridges.

18. A juicer as in claim 7, wherein said strainer is detachably mounted to said base portion.

19. A juicer as in claim 18, wherein said strainer is formed to nest in said base portion.
